(19) United States
(12) Patent Application Publication
(10) Pub. No.: US 2017/0373875 A1
(43) Pub. Date: Dec. 28, 2017

(54) POINT-TO-POINT CHECKOUT AUTOMATION

(71) Applicant: Honeywell International Inc., Morris Plains, NJ (US)

(72) Inventors: Roy Alan Kolasa, Kansas City, MO (US); Cary Leen, Hammond, WI (US); Andrew David Halford, Manchester, MD (US); Jayaprakash Meruva, Bangalore (IN)

(21) Appl. No.: 15/189,958

(22) Filed: Jun. 22, 2016

(51) Int. Cl. H04L 12/28; G06F 13/42; G05B 15/02

(52) U.S. Cl. CPC H04L 12/2816; G05B 15/02; G06F 13/4221

(57) ABSTRACT

Devices, systems, and methods for point-to-point checkout automation are described herein. One device includes a controller of a building system comprising logic to receive a command to perform a point-to-point (PTP) check, and perform the PTP check in response to receiving the command, wherein performing the PTP check includes identifying input/output (I/O) points associated with the controller, scanning each I/O point for a particular functionality based on an I/O type of that I/O point, and determining whether a result of each respective scan is within an expected range for its particular functionality.

### TECHNICAL FIELD

The present disclosure relates to devices, systems, and methods for point-to-point checkout automation.

### BACKGROUND

One or more building systems can be installed in a building to allow for the management of aspects of the building. Building systems can include, for example, heating, ventilation, and air conditioning (HVAC) systems, access control systems, security systems, lighting systems, and fire systems, among others. A building system can refer a single building system (e.g., an HVAC system) and/or a system that manages a number of building systems (e.g., a building management system (BMS)).

Each building system typically includes a plurality of devices. When a building system is commissioned (e.g., at installation), a check may be performed to determine whether devices (e.g., controllers and/or field devices) are connected properly.

Previous approaches to such checks may lack automation and may involve extensive on-site time for one or more commissioning engineers and/or electrical subcontractors. The time taken may involve expenses not only for time spent correcting wiring problems but also for travel time incurred while traveling to the building. Moreover, previous approaches may involve the manual generation of reports on results, which can be time-consuming.

### BRIEF DESCRIPTION OF THE DRAWINGS

FIG. 1 illustrates a system for point-to-point (PTP) checkout automation in accordance with one or more embodiments of the present disclosure.

FIG. 2A illustrates a display for viewing and selecting channels and controllers for PTP checkout automation in accordance with one or more embodiments of the present disclosure.

FIG. 2B illustrates a display for viewing and selecting points of a selected controller for PTP checkout automation in accordance with one or more embodiments of the present disclosure.

FIG. 2C illustrates a display for viewing and configuring a selected point of a selected controller for PTP checkout automation in accordance with one or more embodiments of the present disclosure.

### DETAILED DESCRIPTION

Point-to-point (PTP) checkout automation is described herein. For example, one or more embodiments include a controller of a building system comprising logic to receive a command to perform a point-to-point (PTP) check, and perform the PTP check in response to receiving the command, wherein performing the PTP check includes identifying input/output (I/O) points associated with the controller, scanning each I/O point for a particular functionality based on an I/O type of that I/O point, and determining whether a result of each respective scan is within an expected range for its particular functionality.

Embodiments of the present disclosure can streamline PTP checkout by automating wiring and/or input/output (I/O) checks on building system devices (e.g., controllers and/or field devices). As referred to herein, a wiring check is a check performed to determine whether building system devices are properly connected in a desired configuration. An I/O check, as referred to herein, is sequence of test procedures to determine whether I/O points of one or more system devices of a building are performing as desired. A PTP check can include both a wiring check and an I/O check, in some embodiments. Herein, “connected” refers to devices being electrically connected (e.g., wired) together such that information can be communicated between the devices in a desired manner.

Embodiments of the present disclosure can coordinate the process of a PTP checkout of building system devices for each input and output of those devices based on an expected value range for each I/O and a reading (e.g., taken by one or more sensors). As used herein a “point” refers to a connection point allowing data input, output, or a combination thereof. In some instances, for example, a point may refer to a device terminal and/or port.

Embodiments herein can use one or more databases to determine expected ranges and values to be determined. In some embodiments, a PTP check may be automated (e.g., requiring no user input) for certain values. In some embodiments, a PTP check may be manually advanced (e.g., with user input(s)) to collect point-to-point data on points and/or devices (e.g., points and/or devices not verifiable through detection). For example, manual inputs may be used to verify that a valve and/or actuator is receiving a proper output signal to adjust (e.g., reposition) as commanded.

Accordingly embodiments of the present disclosure can automate a larger portion of PTP checkout compared to previous approaches. Users can be enabled by embodiments herein to verify data and enter results via a mobile device, for instance. Additionally, a summary report can be generated and provided to the user with information such as pass/fail/unknown status on each point, controller, and/or system.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. As used herein, “a” or “a number of” something can refer to one or more such things. For example, “a number of building systems” can refer to one or more building systems.

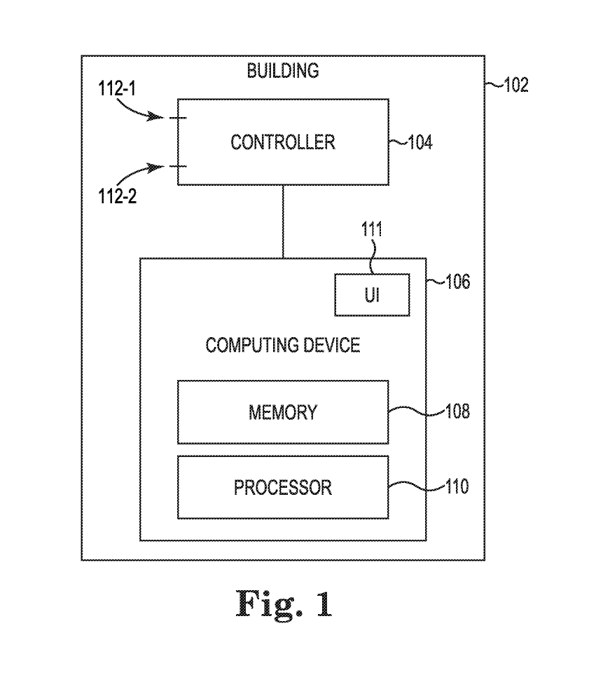

FIG. 1 illustrates a system 100 for PTP checkout automation in accordance with one or more embodiments of the present disclosure. As shown in FIG. 1, system 100 includes a building 102. The building 102 can refer to one or more structures, businesses, homes, plants, facilities, hospitals, refineries, etc.

As shown in FIG. 1, the building 102 can include a controller 104. The controller 104 can be a device configured to control operations of one or more building system devices. For example, the controller 104 can be a building management system (BMS) controller, a controller particular to a device (e.g., a variable air volume (VAV) controller), a zone controller, a unitary controller, and/or a plant controller, among other types of controllers. Though one controller is shown in FIG. 1, embodiments of the present disclosure are not so limited.

A building system can be an HVAC system, an access control system, a security system, a lighting system, and a fire system, among others. The building system of the building 102 can include one or more I/O devices (e.g., field devices) such as, for example, an air handling unit, a variable air volume (VAV) device, a thermostat, a security camera, an access control device, a sensor, and an alarm. The devices can be managed by the controller 104 and can participate in a network (e.g., a connected building system) of other devices. The devices can be wired and/or wirelessly connected to the controller 104 such that the devices and the controller can communicate information with one another. In some embodiments, the controller 104 can control operations of a single device.

As shown in FIG. 1, the system 100 can include a computing device 106. Though in the example illustrated in FIG. 1 the computing device 106 is shown local to the building 102 (e.g., inside the building 102), embodiments of the present disclosure are not so limited. In some embodiments, the computing device 106 can be remote with respect to the building 102. In some embodiments, the computing device 106 can be a remote server (e.g., a cloud-hosted service). In some embodiments, the computing device 106 can be a mobile device. In some embodiments, the computing device can be a local control panel and/or operator station.

The computing device 106 can include a memory 108 and a processor 110 configured to execute executable instructions stored in the memory 108 to perform various examples of the present disclosure, for example. That is, the memory 108 can be any type of non-transitory storage medium that can be accessed by the processor 110 to perform various examples of the present disclosure. For example, the memory 108 can be a non-transitory computer readable medium having computer readable instructions (e.g., computer program instructions) stored thereon that are executable by the processor 110.

The memory 108 can be volatile or nonvolatile memory. The memory 108 can also be removable (e.g., portable) memory, or non-removable (e.g., internal) memory. For example, the memory 108 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although the memory 108 is illustrated as being located within the computing device 106, embodiments of the present disclosure are not so limited. For example, the memory 108 can also be located internal to another computing resource (e.g., enabling computer readable instructions to be downloaded over the Internet or another wired or wireless connection).

In addition to, or in place of, the execution of executable instructions, various examples of the present disclosure can be performed via one or more devices (e.g., one or more controllers) having logic. As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. It is presumed that logic similarly executes instructions for purposes of the embodiments of the present disclosure. For instance, the controller 104 can include logic to perform various functions in accordance with embodiments of the present disclosure.

As previously discussed, the computing device 104 can be a mobile device in some embodiments. The mobile device can be a client device carried or worn by a user. For example, the mobile device can be a phone (e.g., smartphone), personal digital assistant (PDA), tablet, and/or wearable device (e.g., wristband, watch, necklace, etc.). The mobile device can include one or more software applications (e.g., apps) which can define and/or control communications between the mobile device, the controller 104, and/or a remote computing device (e.g., a cloud hosted service). Apps may be received by the mobile device from one or more other computing devices. Apps may be launched by a user and/or responsive to some other condition. In some embodiments, apps can be executing as background apps.

As shown in FIG. 1, the computing device 106 can also include a user interface 111. The user interface 111 can include a display (e.g., a screen). The display can be, for instance, a touch-screen (e.g., the display can include touch-screen capabilities). The user interface 111 can provide (e.g., display and/or present) information to a user of the computing device 106.

Additionally, the computing device 106 can receive information from the user of computing device 106 through an interaction with the user via user interface 111. For example, computing device 106 (e.g., the display of user interface 111) can receive input from the user via the user interface 111. The user can enter the input into computing device 111 using, for instance, a mouse and/or keyboard associated with the computing device 106, or by touching the display of the user interface 111 in embodiments in which the display includes touch-screen capabilities (e.g., embodiments in which the display is a touch screen).

The controller can include a point 112-1 and a point 112-2, sometimes cumulatively referred to as “points 112.” One or both of the points 112 can be an input point, an output point, or a combination thereof (e.g., an I/O point). Herein, where not specifically indicated, an “I/O point” may refer to an output point, an input point, or an input/output point. It is noted that while two points are illustrated in FIG. 1, embodiments of the present disclosure are not so limited; devices in accordance with embodiments herein can have more or fewer than two points. One or more of the points 112 can be an analog point. One or more of the points can be a digital point.

Additionally, though the points 112 are shown in FIG. 1 as being physically included in the controller 104 as “onboard” points, embodiments herein are not so limited. In some embodiments, the points 112 can be located on an I/O bus, for instance, in communication with the controller 104. For example, one or more points can be included in in I/O module along an I/O bus connected to the controller 104.

The controller 104 can include configuration details. In some embodiments, for instance, the configuration details can be received (e.g., downloaded) from the computing device 106 as an application (e.g., application logic). The configuration details can include configuration information associated with a network in which the controller 104 is participating, a channel of the network, and/or I/O points of the controller. For example, configuration details can include device type, settings, network infrastructure, hierarchies, and/or relationships, among other details.

A channel can include a particular subset of a network of a building system. For example, a channel can refer to a floor, a region, and/or a zone of the building 102, though embodiments of the present disclosure are not so limited. In some embodiments, a channel can refer to a particular group of devices that communicate using a particular set of network protocols (e.g., Fieldbus, Modbus, etc.).

In some embodiments, the controller 104 may not include the configuration details at an outset of the PTP check. For example, the controller 104 may be a new device or may not have been pre-loaded with the application having the configuration details. In such cases, a user may enter (e.g., upon being prompted) configuration details for controller(s), channel(s), and/or system(s). Such entry can be made via the computing device 106, for instance.

Embodiments of the present disclosure can include instructions executable by the controller 104 to perform a PTP check responsive to commands to do so received from the computing device 106. The command can be input to computing device 106 by a user. For example, in some embodiments, the user can select a particular controller (e.g., the controller 104) from a list and/or tree of controllers indicating that a PTP check is to be performed on the controller. The list of controllers can be filtered by channel, physical location (e.g., building floor), and/or by system (e.g., AHU and associated VAVs). The list of controllers can indicate (e.g., via different symbols, graphics, colors, fonts, embellishments, etc.) which controllers are online, which controllers have already been checked, and/or which controllers have configuration details downloaded to them. Further, the computing device 106 can monitor the status of the PTP check as it is being performed.

Based upon the configuration details (e.g., the channel configuration details) the controller can determine types of devices (e.g., circuit boards) that are capable of being connected to the channel (e.g., interfacing with the channel protocol). Based on the types of devices, the controller 104 can identify the different I/O points of those devices, perform a wiring check on each I/O point, and scan each I/O point for a particular functionality based on its I/O type. For example, a first device may have an analog input point, and a second device may have a digital input point. For each type of I/O point, there may exist a respective set of I/O scan steps. For instance, via the computing device 106, a user can toggle digital output points off and on and observe that a device (e.g., the controller 104) turns off and on accordingly. Further, the particular functionality may be based on a set of I/O characteristics reflecting expected values for that I/O point.

For an analog input point, for instance, the scan may be carried out in two steps in some embodiments. First, a signal from an input device (an air handling unit (AHU), in this example), can be received and the resultant value can be analyzed to determine whether the input device is connected or not. The signal can be a voltage signal, for instance, which can be converted to an analog value. Further, calibration data received for the input device may be used to configure an offset value for the point.

Second, to determine whether a correct (e.g., desired) sensor is connected to the controller 104, embodiments of the present disclosure can apply (e.g., compare) all known I/O characteristics on the signals received by the controller 104 and predict whether the correct sensor is connected. If the I/O characteristics are applicable (e.g., compare to the signals received) beyond a threshold, the sensor can be determined to be correct.

If an incorrect sensor is determined to be connected, the controller 104 can record details about what sensor is expected (e.g., desired) and what sensor is actually connected (e.g., a name and/or type of the sensor actually connected). For example, a PT1000 sensor is wired to U11 point of controller CPO-10830 board 1, but the expected sensor is actually NTC20K. A notification of such details can be communicated to, and/or displayed by, the computing device 106.

If the correct sensor is connected and a converted signal value is out of the application context, then embodiments the present disclosure can provide a notification to that effect to the computing device 106. Such an issue may be caused by the sensor being faulty or being connected to the wrong controller. For example, in an AHU application, the room temperature sensor can be expected to provide a certain range and is supposed to be connected to input terminal 1 (e.g., point 112-1). Embodiments of the present disclosure can assume that the room temperature sensor is actually connected to a chilled water input of the AHU if the actual value is measured to be much lower than room temperature.

Further, embodiments of the present disclosure can provide a user with the ability to adjust expected values (e.g., I/O characteristics) and/or calibrate field devices within the UI 111 during a PTP checkout. For instance, in performing a check on an analog input point for a VAV controller, the user can adjust a characteristic temperature range (e.g., change the range “−50 to 150 degrees C.” to “−50 to 140 degrees C.”

If a current measured temperature by the VAV device is 53 degrees C. and an actual measured temperature (measured by a separate temperature sensor) is 50 degrees C., embodiments of the present disclosure can prompt the user to enter an offset value (e.g., −3 degrees C.) in order to calibrate the device. In some embodiments, the calibration can be automatic (e.g., without user input). For example, the separate temperature sensor can be in communication with the computing device 106 and/or the controller 104 and can communicate an actual measured temperature. The actual measured temperature can be used to determine and set an offset.

For an analog output point, embodiments of the present disclosure can associate the output point with a corresponding feedback input point. Random analog values can be forced (e.g., sent) to the analog output point based on I/O characteristics and/or the application context. The associated feedback signals can be analyzed to determine whether commanded output signal has changed its value to a desired value (e.g., within the context of the I/O characteristics). Any exceptions can be analyzed to determine whether the output device is actually connected and/or whether it is working within its expected range (e.g., functioning properly). In some embodiments, the computing device 104 can allow the user to adjust output range from 0% to 100%. These data values can be displayed via the UI 111, and can be updated automatically (e.g., without user input).

Results of the PTP check can be provided to, and displayed by, the computing device 106. Results can include data generated by the controller 104 resulting from the execution of the PTP check such as, for instance, whether the result of the scan of the PTP check is within an expected range or exceeds an expected threshold. Results can include a list of steps executed, a list of devices tested, ordering of tests, measured values associated with the devices tested, time stamps, etc. For example, results can include tests performed for a given device, when those tests were performed, whether the device passed or failed, and/or whether the device could not be tested.

In some embodiments, results may be returned as they are determined (e.g., in real time). In some embodiments, results may be returned at the completion of the PTP check, or at some other time, such as the completion of a step of the check.

Determining whether a point, controller, and/or system passed or failed can include comparing the results with industry standards, desired operating parameters, system requirements, etc. Passing or failing a step of a PTP check can include a result having variation from an expected and/or desired result (e.g., an “abnormality”) that is outside an expected range or exceeds a particular threshold. For instance, when a digital output is turned on or off, when an input has been shorted or opened, or when an analog output has been adjusted to a desired setting, the controller can provide a pass/fail selection to the computing device 106. The user, via the computing device 106, can refer back to a list of points of the controller and view the entered (e.g., selected) pass/fail status for each.

Embodiments of the present disclosure can additionally verify that I/O devices are terminated correctly, verify the integrity of wiring between controller(s) and I/O devices, and determine and display one or more possible reasons why a device may have failed a PTP checkout. Any failing devices can be viewed in enhanced detail and can be re-run through the checkout.

The results can be used to generate reports, for instance. In some embodiments, reports can be generated without user input (e.g., automatically). A notification can be provided to a user via the computing device 106 that a report has been generated. A report can be communicated to the UI 111 of the computing device 106. In some embodiments, a report can be included in an email. Further, based on the results of a PTP checkout, embodiments of the present disclosure can provide an indication associated with controllers that are ready for a functional checkout.

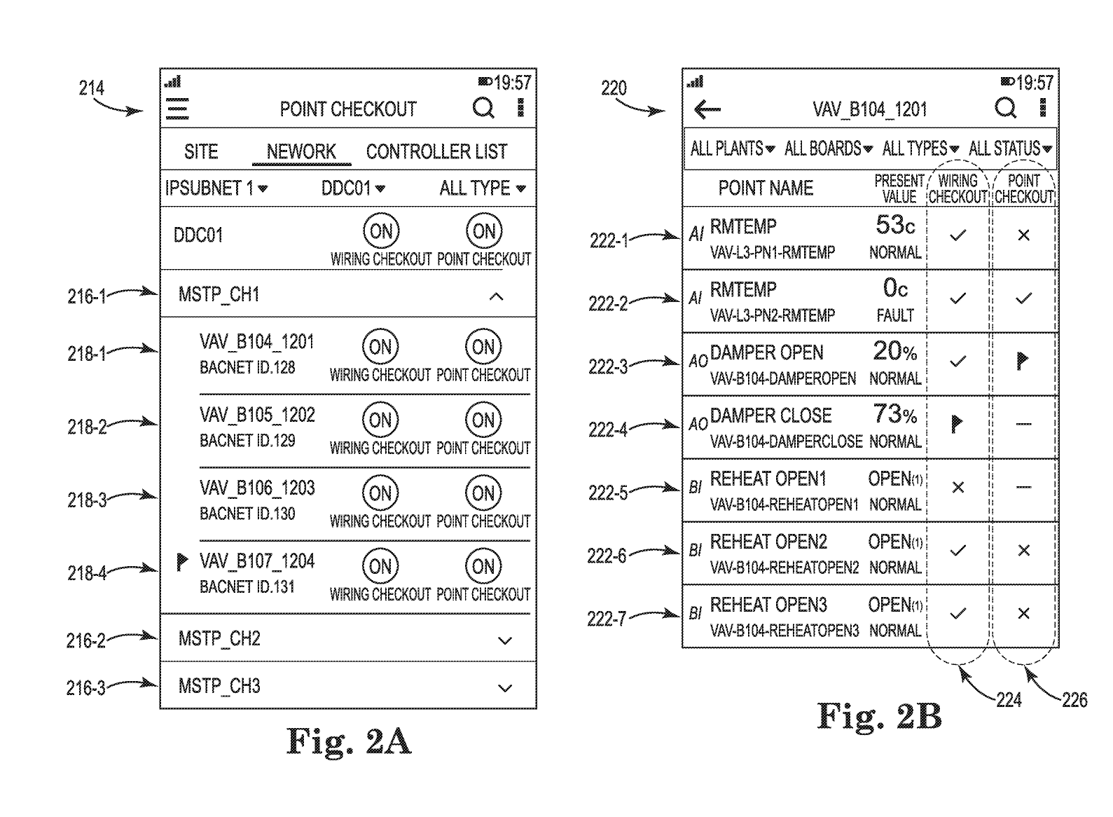

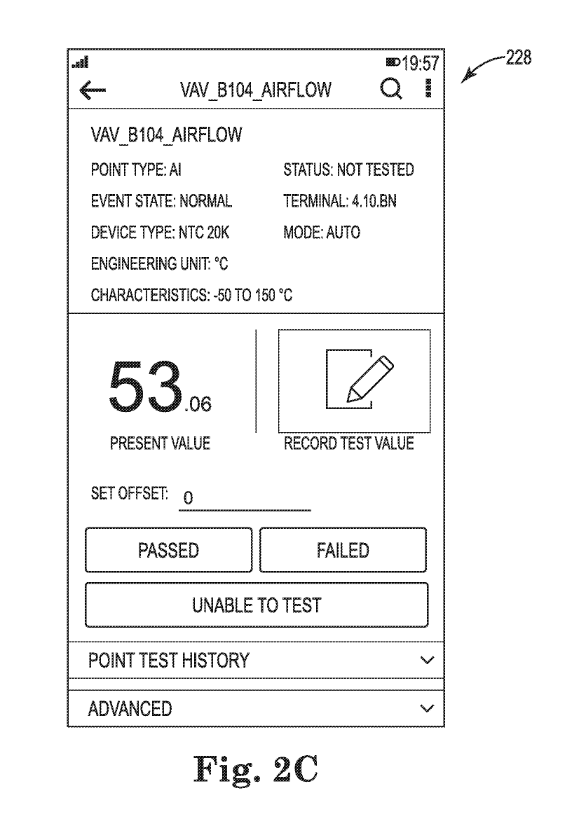

FIGS. 2A, 2B, and 2C illustrate different displays for PTP checkout automation in accordance with one or more embodiments of the present disclosure. The displays illustrated in FIGS. 2A, 2B, and 2C can be presented by a user interface, such as user interface 111, previously described in connection with FIG. 1, for instance. It is noted that embodiments of the present disclosure are not limited to the particular layout, configuration, and/or appearance illustrated in FIGS. 2A, 2B, and 2C. Moreover, the particular device types and/or devices depicted in FIGS. 2A, 2B, and 2C are included as examples to illustrate aspects of embodiments herein and are not to be taken in a limiting sense.

FIG. 2A illustrates a display 214 for viewing and selecting channels and controllers for PTP checkout automation in accordance with one or more embodiments of the present disclosure. The display 214 can be a display for selecting controllers for which to perform a PTP checkout, for instance. The display 214 includes a plurality of selectable channels; a channel 216-1, a channel 216-2, and a channel 216-3 (cumulatively referred to as “channels 216”). As shown in FIG. 2A, the channel 216-1 has been selected, showing a list of unitary controllers in the channel 216-1. For instance, the channel 216-1 includes a controller 218-1, a controller 218-2, a controller 218-3, and a controller 218-4. If the user selects the unitary controller 218-1, for instance, the display 220 illustrated in FIG. 2B can be presented.

FIG. 2B illustrates a display 220 for viewing and selecting points of a selected controller for PTP checkout automation in accordance with one or more embodiments of the present disclosure. For instance, the display 220 includes a plurality of points; a point 222-1, a point 222-2, a point 222-3, a point 222-4, a point 222-5, a point 222-6, and a point 222-7 (cumulatively referred to herein as “points 222”). Of the points 222, 1-4 are analog, and 5-7 are digital, as shown in FIG. 2B.

In the example illustrated in FIG. 2B, the points 222-1 and 222-2 are analog input points, the points 222-3 and 222-4 are analog output points, and the points 222-5, 222-6, and 222-7 are digital input points. As shown in FIG. 2B, present values associated with each of the points can be displayed. The present values can be temperatures, for instance, as shown in FIG. 2B, though embodiments of the present disclosure are not so limited and the values illustrated in FIG. 2B are not to be taken in a limiting sense.

As shown in FIG. 2B, the points 222-5, 222-6, and 222-7 have present values of “open.” This designation may indicate that these points may not yet be configured and a present value is not available.

As shown in FIG. 2B, a wiring checkout status column 224 can be displayed that provides a wiring checkout status associated with each of the points 222. In some embodiments, a checkmark can indicate a pass, an “X” can indicate a fail, and a flag can indicate that a check was not performed for a particular point and/or that further attention may be desired.

A point (e.g., I/O) checkout column 226 can be displayed that provides an I/O checkout status associated with each of the points 222. In some embodiments, a checkmark can indicate a pass, an “X” can indicate a fail, and a flag can indicate that a check was not performed for a particular point and/or that further attention may be desired. If the user selects a point “VAV_B104_AirFlow” (obscured in FIG. 2B) from the list, the display 228 illustrated in FIG. 2C can be presented.

FIG. 2C illustrates a display 228 for viewing and configuring a selected point of a selected controller for PTP checkout automation in accordance with one or more embodiments of the present disclosure. The display 228 is associated with the point “VAV_B104_AirFlow.”

As shown in FIG. 2C, the display 228 can include information about the point including, for instance, point type, event state, device type, engineering unit, characteristics, test status, terminal, mode, etc. Additionally, the display 228 can include a portion configured to receive an actual measured temperature (e.g., calibration data) for offset purposes. As previously discussed, if a current measured temperature (shown in the display 228 as 53.06 degrees C.) differs from an actual measured temperature (measured by a separate temperature sensor), embodiments of the present disclosure can prompt the user to enter an offset value in order to calibrate the point. The actual measured temperature can be used to determine and set an offset.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A controller of a building system, comprising logic to:
receive a command to perform a point-to-point (PTP) check; and
perform the PTP check in response to receiving the command, wherein performing the PTP check includes:
identifying input/output (I/O) points associated with the controller;
scanning each I/O point for a particular functionality based on an I/O type of that I/O point; and
determining whether a result of each respective scan is within an expected range for its particular functionality.

2. The controller of claim 1, wherein the command is received from a remote computing device.

3. The controller of claim 1, wherein the command is received from a mobile device.

4. The controller of claim 1, wherein the I/O points are onboard the controller.

5. The controller of claim 1, wherein the I/O points are on an I/O bus in communication with the controller

6. The controller of claim 1, wherein the controller is one of a plurality of controllers of a building, and wherein each controller is configured to perform the PTP check responsive to a respective command.

7. The controller of claim 1, wherein the I/O points associated with the controller are identified based on configuration details of the controller.

8. The controller of claim 7, wherein the configuration details are received from a computing device.

9. The controller of claim 7, wherein the configuration details include configuration information associated with a network in which the controller is participating, a channel of the network that includes the controller, and the I/O points of the controller.

10. The controller of claim 1, wherein the particular functionality for each respective I/O point is based on a set of I/O characteristics reflecting expected values for that I/O point.

11. A system for point-to-point (PTP) checkout automation, comprising:
a controller of a building system; and
a computing device configured to:
receive an input associated with a command to perform a PTP check on the controller;
communicate the command to the controller responsive to receiving the input;
monitor a status of the PTP check performed by the controller in response to receiving the command from the computing device;
display whether results of the PTP check are within an expected range or exceed an expected threshold.

12. The system of claim 11, wherein the controller is configured to:
receive a signal from an input device; and
determine whether the input device is connected to the controller based on a value associated with the signal.

13. The system of claim 11, wherein the controller is configured to:
compare input/output (I/O) characteristics of the controller to a signal received by an analog input point associated with the controller; and
determine whether a sensor connected to the controller is a correct sensor based on the comparison exceeding an expected threshold.

14. The system of claim 13, wherein, the controller is configured to determine a type of the sensor connected to the controller upon determining the sensor connected to the controller is not a correct sensor.

15. The system of claim 13, wherein the computing device is configured to provide a notification upon the controller determining that the sensor connected to the controller is a correct sensor.

16. The system of claim 11, wherein the controller is configured to:
associate an analog output point with an analog input point of the controller;
send a plurality of analog values to the analog output point based on I/O characteristics of the controller; and
determine whether a value of an output signal associated with the analog output point has changed to a particular value.

17. A method for point-to-point (PTP) checkout automation, comprising:
Receiving, by a controller of a building system, a command to perform an PTP check thereon; and
performing the PTP check in response to receiving the command, wherein performing the PTP check includes:
identifying I/O points of the controller;
performing, by the controller, a wiring check on each respective I/O point of the controller;
scanning each respective I/O point of the controller for a particular functionality based on an I/O type of that respective I/O point;
receiving calibration data for an input device associated with one of the I/O points; and
configuring an offset value for the one of the I/O points on the received calibration data.

18. The method of claim 17, wherein the controller is one of a unitary controller and a plant controller.

19. The method of claim 17, wherein the method includes:
determining whether the PTP check on the controller failed; and
determining, upon determining the PTP check failed, a possible reason for the failure.

20. The method of claim 17, wherein the command is sent from a mobile device responsive to a user selection of the controller from a list of a plurality of controllers sorted by channel.
